(19) United States
(12) Patent Application Publication
(10) Pub. No.: US 2012/0206267 A1
(43) Pub. Date: Aug. 16, 2012

(54) Key Fob Indicator Apparatus

(75) Inventors: Mitchell V. Holden, Strongsville, OH (US); Dennis F. Reese, Medina, OH (US)

(73) Assignee: DFR GROUP, INC., Medina, OH (US)

(21) Appl. No.: 13/367,180

(22) Filed: Feb. 6, 2012

Related U.S. Application Data
(60) Provisional application No. 61/441,306, filed on Feb. 10, 2011.

(51) Int. Cl. G08B 21/00

(52) U.S. Cl. 340/644

(57) ABSTRACT

An indicator apparatus is provided which may be wrapped around and/or may encase a key fob that wirelessly locks and unlocks doors of a vehicle. The apparatus includes first and second spaced apart switches which are respectively associated with first and second light emitters and which are aligned to cover the respective lock and unlock buttons of the key fob. A controller is responsive to activation of the first and second switches to store data in the memory that represents which of the first and second switches was activated most recently. The controller is responsive to activation of the third switch and the data stored in the memory to cause the respective first or second light emitter to emit light when the data stored in the memory is indicative of the respective first or second switch being activated more recently than the other one of the first or second switch.

### BACKGROUND

Many vehicle are equipped with door locks that are capable of automatically locking or unlocking the doors responsive to wireless signals such as radio frequency (RF) signals. These vehicles may be associated with portable wireless transmitters capable of transmitting the necessary wireless signals that cause the locks to lock or unlock the doors. Typically, such wireless transmitters are provided in the form of a key fob that is connected to or is adapted to be connected to one or more keys. For example, a key fob may include a metal ring to which keys may be attached. Such keys may include an ignition/door key for the vehicle and/or other keys (e.g., keys for locks associated with home doors, garages, safes, padlocks, and other objects). Other key fobs may be directly attached to an end of an ignition key and may include one or more rings for attaching additional keys to the key fob.

Such key fobs (and/or the ignition key mounted thereon) may also include an integrated radio-frequency identification (RFID) chip/circuit that is required to be placed near the ignition lock of the vehicle in order to enable the engine of the vehicle to be started. Also, such key fobs may include additional buttons that are operative to wirelessly activate an alarm siren in the vehicle and/or carry out other actions such as opening and closing sliding doors, trunk lids and hatches of the vehicle.

Key fobs offer a user the ability to more conveniently lock and unlock door locks from a distance of many yards from the vehicle. However, because a user no longer needs to directly lock the doors of the vehicle, the capability of wirelessly locking a vehicle may increase the likelihood that the user forgets to lock the vehicle. Thus improvements to the technology associated with locking and unlocking doors may be needed.

### SUMMARY

The following is a brief summary of subject matter that is described in greater detail herein. This summary is not intended to be limiting as to the scope of the claims.

In example embodiments, key fobs may be adapted to have the capability to provide an indication as to which of the lock and unlock buttons of the key fob was last pressed. For existing key fobs, example embodiments of the invention described herein may correspond to at least one flexible band that wraps around the key fob and/or may correspond to an enclosure which encases the key fob. Such an at least one band or enclosure may include a circuit capable of detecting lock/unlock button presses for use with providing the indication of which button was last pressed. In an alternative embodiment, key fobs may be manufactured to include an integrated circuit that provides this indication.

These described embodiments may include first and second spaced-apart switches which are respectively associated with first and second light emitters. For the embodiment that wraps around and/or encloses at least portions of the key fob, the first and second switches may be positioned so as to be aligned to cover the respective lock and unlock buttons of the key fob. When a user presses either switch, the underlying lock/unlock button is pushed as well to cause a door of a vehicle to be wirelessly locked or unlocked by the key fob. For the key fob that is manufactured to include an indicator circuit, the first and second switches may correspond to the actual lock and unlock buttons of the key fob.

In these example embodiments, a controller (whether in operative supported connection with the at least one flexible band and/or the enclosure or integrated into the housing of the key fob) is responsive to activation of the first and second switches to store data in a memory that represents which of the first and second switches was activated most recently. The controller is also responsive to the data stored in the memory and activation of a third switch (in operative connection with the controller), to cause either the first or second light emitter to emit light. In this described embodiment, the particular first or second light emitter that is turned on to emit light is based on which one of the associated first or second switches the memory data indicates was activated more recently. Thus if the lock button was last pushed, the controller causes the light emitter adjacent to the lock button to emit light. Also, if the unlock button was last pushed, the controller causes the light emitter adjacent the unlock button to emit light.

With these described embodiments, a user may press the third button when the user needs to receive a visual reminder (via one of the light emitters) regarding whether the lock button or the unlock button was last pressed. If the user intended to lock a vehicle, an indication that the lock button was last pressed can reassure the user that the vehicle is likely in a locked state. Conversely, if there is an indication that the unlock button was last pressed, then user can go back to the vicinity of the vehicle and use the key fob to lock the doors.

Other aspects will be appreciated upon reading and understanding the attached figures and description.

### BRIEF DESCRIPTION OF THE DRAWINGS

FIG. 1 shows a cross-sectional side schematic view of an example embodiment of a key fob indicator apparatus.

FIG. 2 shows a perspective view of the apparatus mounted to a key fob.

FIG. 3 shows a front plan view of the apparatus mounted to a key fob.

FIG. 4 shows a top plan view of the apparatus mounted to a key fob.

FIG. 5 shows a front plan view of an alternative example embodiment of a key fob indicator apparatus mounted to a key fob.

FIG. 6 shows a back perspective view of the alternative example embodiment of the apparatus mounted to a key fob.

FIG. 7 shows a front schematic view of a further alternative example embodiment of an indicator apparatus integrated into a key fob.

FIG. 8 shows a front schematic view of a further alternative example embodiment of an indicator apparatus having an enclosure operative to encase a key fob.

FIG. 9 shows a cross-sectional view of the indicator apparatus shown in FIG. 9.

FIG. 10 is a flow diagram that illustrates an example methodology for operating a key fob indicator apparatus.

### DETAILED DESCRIPTION

Various technologies pertaining to key fobs will now be described with reference to the drawings, where like reference numerals represent like elements throughout. In addition, it is to be understood that functionality that is described as being carried out by certain system components may be performed by multiple components. Similarly, for instance, a component may be configured to perform functionality that is described as being carried out by multiple components.

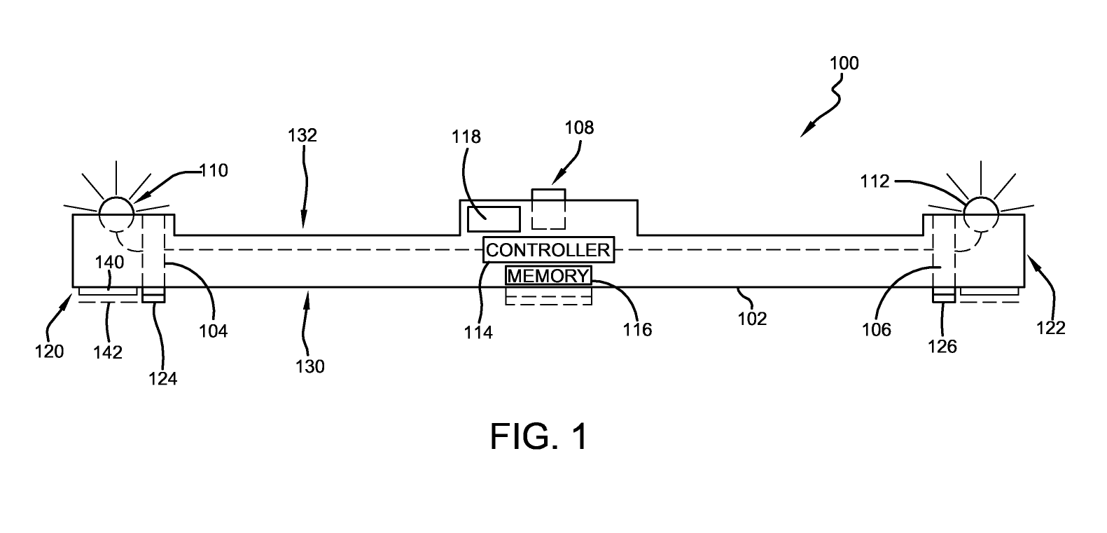

With reference to FIG. 1, a cross-sectional schematic side view of an example key fob indicator apparatus 100 is illustrated. The apparatus 100 includes a body 102. The apparatus also includes (in operative supported connection with the body) a first switch 104 and a second switch 106. The first and second switches are spaced apart along the body.

The apparatus may also include (in operative supported connection with the body) a third switch 108, and one or more output devices such as a first light emitter 110 and a second light emitter 112. The first and second light emitters are spaced apart along the body such that each is respectively adjacent different portions of the body 102 that includes the respective first and second switches 104, 106. In this described embodiment, the light emitters may correspond to one or more LEDs. However, in alternative embodiments other types of output devices may be used that are operative to output information (e.g., LCD display, sound emitters, etc.).

As illustrated in FIG. 1, the apparatus may include a controller 114 in operative connection with the first switch 104, the second switch 106, the third switch 108, the first light emitter 110 and the second light emitter 112. The controller may include or may be in operative connection with a memory 116. Also, the body may include a battery 118 which is capable of providing power to the controller.

In this described embodiment, the controller may correspond to a processor or an integrated circuit chip that is operatively configured or programmed to control (and/or operate responsive to) the switches and light emitters. However it should be appreciated that in alternative embodiments, the controller may correspond to an analog circuit without a processor or integrated circuit chip, which is operatively configured to carry out corresponding functions described herein.

In example embodiments, the controller is operatively configured to be responsive to activation (e.g., pressing) of the first and second switches to store data in the memory that represents which of the first and second switches was activated most recently. In addition, the controller is operatively configured to be responsive to activation of the third switch and the data stored in the memory to cause the first light emitter to emit light when the data stored in the memory is indicative of the first switch having been activated more recently than the second switch. Also, the controller is operatively configured to be responsive to activation of the third switch and the data stored in the memory, to cause the second light emitter to emit light when the data stored in the memory is indicative of the second switch being activated more recently than the first switch.

In an example embodiment, the body 102 may include at least one flexible band that is operative to enable the apparatus to wrap around at least a portion of the key fob. The first switch 104 and the first light emitter 110 may be positioned on a first end 120 of the body 102, while the second switch 106 and second light emitter 112 may be positioned on an opposed second end 122 of the body 102.

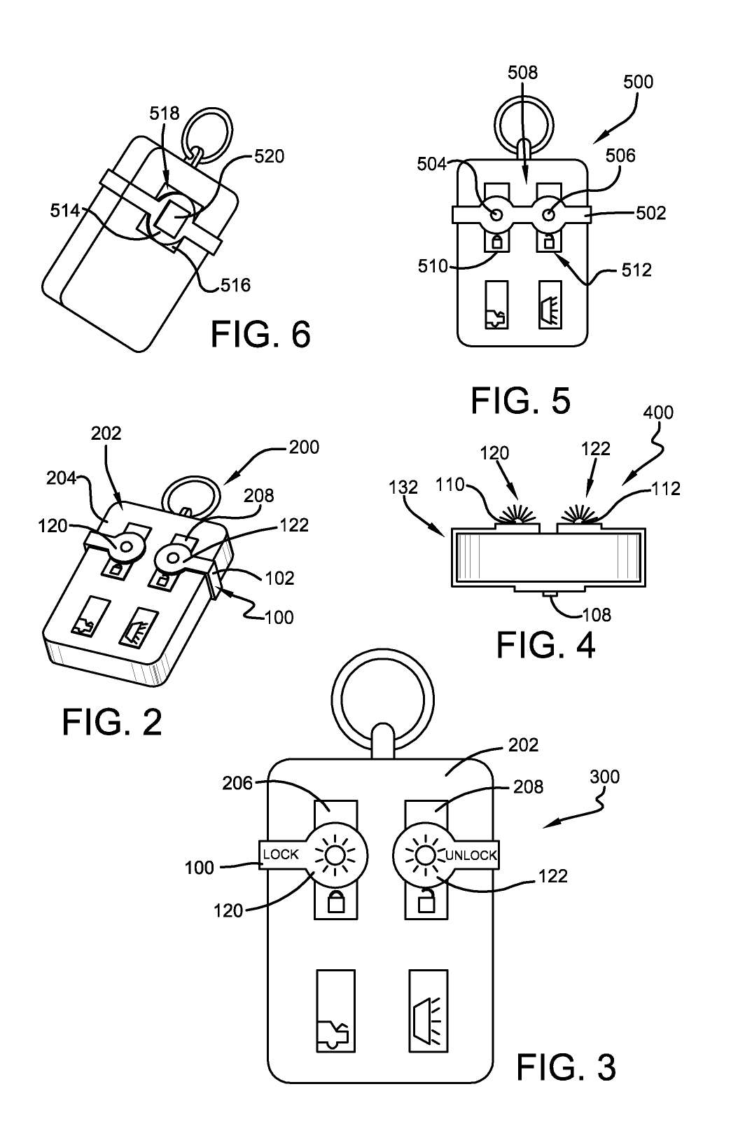

FIG. 2 shows a perspective view 200 of an example key fob 202, in which the described body 102 of the indicator apparatus 100 is wrapped around a housing 204 of the key fob. As shown in FIG. 2, the described body 102 has a length which is sufficient to enable the two ends 120, 122 to be adjacent different buttons 206, 208 of the key fob 202.

FIG. 3 shows a top plan view 300 of the key fob 202 with the indicator apparatus 100 wrapped therearound. As shown in FIG. 3, the buttons 206 and 208 correspond to lock and unlock buttons, respectively. This described key fob is operative to wirelessly lock doors of a vehicle responsive to the lock button 206 being pressed. Likewise, the key fob is operative to wirelessly unlock the doors of the vehicle responsive to the unlock button 208 being pressed.

With the indicator apparatus mounted to a key fob 202 as shown in FIGS. 2 and 3, pressing (e.g., pushing down) on the ends 120, 122 of the indicator apparatus is operative to cause the respective lock and unlock buttons 206, 208 to be pressed as well, which thereby locks and/or unlocks the doors of a vehicle. In addition, because the switches 104, 106 (shown in FIG. 1) are also mounted on the ends 120, 122 of the indicator apparatus, pressing the ends (to cause locking or unlocking of the doors of the vehicle) further causes the respective switches to be activated.

To facilitate the switches being activated, as shown in FIG. 1, the first and second ends 120, 122 may include respective first 124 and second 126 projections that extend outwardly from an inner face surface 130 of the body 102. These first and second projections may 124, 126 be included by and/or are in operative connection respectively with the first and second switches 104, 106. These projections extend a sufficient length from the immediately surrounding inner surfaces 130 to be capable of causing the switches 104, 106 to be activated (in a manner that is detectable by the controller) when manual pressure is applied on the opposed ends 120, 122, to push down on the respective lock and unlock buttons of the key fob.

In this described embodiment, the projections 124, 126 may correspond to portions of the switches themselves. However, in alternative embodiments, the projections 124, 126 may correspond to movable portions of the body which are operative to activate the switches mounted inside the ends 120, 122 of the body.

As shown in FIG. 1, the body 102 also includes an outer face surface 132. As illustrated in the side view 400 shown in FIG. 4, the first and second light emitters 110, 112 may be mounted in the body in a manner (e.g., facing outwardly) that is operative to enable the light emitters to output light that is visible when looking at the outer face surface 132 of the body of the indicator apparatus. Also, in this described embodiment, the third switch 108 may mounted adjacent the outer face surface 132 in a location that is between the opposed ends 120,122. As a result, when the described indicator apparatus is mounted around a key fob, the third switch 108 is accessible to be pushed by a user on the back of the key fob. However, in alternative embodiments (as described below in more detail) it should be appreciated that the third switch 108 may be located on the body in a different location (e.g., such as to enable the third switch to be on the top of the key fob adjacent the first and second light indicators 110, 112.)

In order to mount the indicator apparatus, the inner face surface of the body may include a pressure-sensitive adhesive that is operative to adhesively adhere the apparatus in place to surfaces of the key fob. For example, as illustrated in FIG. 1, the inner face surfaces 130 at the opposed ends 120, 122 may include one or more locations with an adhesive 140. When the indicator apparatus is manufactured, one or more removable release liners 142 may be placed over the adhesive to protect the adhesive prior to mounting the indicator apparatus to a key fob.

In the previously described embodiment, the light emitters and switches are mounted on the opposed ends of the body of the indicator apparatus. For example, such light emitter and switches may be mounted to opposed ends of first and second ribbon cables (with wires therein) connected to opposite sides of a circuit board that includes the described controller. However, it should be appreciated that in alternative embodiments, the various switches and light emitters may be positioned at other locations and/or may be connected together in a different configuration. Further, alternative embodiments may use other mechanisms (besides an adhesive) to mount the indicator apparatus to a key fob.

For example, FIG. 5 illustrates an alternative embodiment 500 of the indicator apparatus in which the locations of the light emitters and corresponding switches are not positioned on the ends of the body 502 of the indicator apparatus. Rather, as shown in FIG. 5, the light emitters 504, 506 and corresponding switches (mounted below the light emitters) are positioned generally adjacent to the middle 508 of the body. With this arrangement, the switches and corresponding projections (which activate the buttons of the key fob) are spaced apart adjacent to the middle 508 of the body a sufficient distance that corresponds to the distances the lock and unlock buttons 510, 512 are spaced apart on the key fob.

As illustrated in FIG. 6 (which shows a back of the key fob), the opposed ends 514, 516 of the body may be adapted to connect to each other (to form a continuous loop) via hook-and-loop fasteners 518 (or other types of fasteners) mounted on the opposed ends 514, 516. In this described alternative embodiment, the previously described third button 520 and/or the controller may be mounted in one of the ends 514, 516 of the body. However, in a further embodiment, the third button 520 may be located adjacent the middle 508 of the body.

In one or more of the previously described embodiments, the body may include one or more flexible portions (such as ribbon cables) and/or stretchable portions (such as a natural and/or synthetic rubber or a stretchable woven fabric) to enable the body to extend around different models of key fobs (with different sizes and shapes). Also, in a further alternative embodiment, the body may be formed as a continuous loop, which has no opposed ends. This further embodiment may be similar to the embodiment shown in FIGS. 2 and 3 with the addition of a portion of the body which connects the ends 120, 122. This further embodiment may be comprised of a stretchable material as well, to enable it to increase an interior area that is bounded by the loop of the body (to accommodate key fobs of different sizes).

The previously described embodiments correspond to a body in the form of one or more flexible bands that enable the indicator apparatus to wrap around a key fob. However, it should be appreciated that another alternative embodiment may include the described indicator apparatus in a form that is mounted or integrated into the key fob itself.

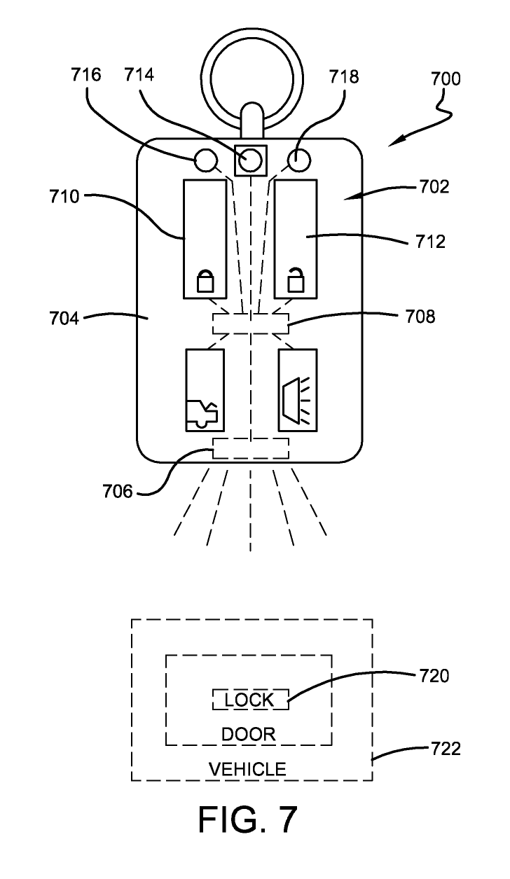

FIG. 7 illustrates an example embodiment of such an alternative embodiment of the indicator apparatus 700 which is integrated into a key fob 702 (which facilitates wireless remote locking and unlocking of locks). Here the previously described body of the indicator apparatus corresponds to the housing 704 of the key fob. Such a key fob includes an RF transmitter (schematically indicated 706) mounted in the housing 704 in operative connection with a controller (schematically indicated 708).

In this described embodiment, the previously described first and second switches correspond to a switch 710 that corresponds to the lock button and a switch 712 that corresponds to the unlock button. As with conventional key fobs, the controller is responsive to activation of the first switch 710 (i.e., the lock button) to cause the RF transmitter to emit an RF signal that is operative to cause at least one lock device 720 of a vehicle 722 (or other object) to change from an unlocked configuration to a locked configuration. Likewise, the controller is responsive to activation of the second switch 712 (i.e., the unlock button) to cause the RF transmitter to emit an RF signal that is operative to cause the at least one lock device 720 to change from the locked configuration to the unlocked configuration. Further, as with the previously described controller 114 (shown in FIG. 1), the controller 712 is responsive to activation of the first and second switches to store, in a memory, data that represents which of the first and second switches was activated most recently.

In addition, as shown in FIG. 7, the housing of the key fob 704 may further include (integrated therein) a third switch 714, as well as the first and second light emitters 716, 718 positioned adjacent to (e.g., above) the respective switches 710, 712 (i.e., the lock and unlock buttons). In this described embodiment, the controller 708 is responsive to activation of the third switch 714 and the data stored in the memory to cause the respective first or second light emitter to emit light when the data stored in the memory is indicative of the respective first or second switch being activated more recently than the other one of the first or second switch.

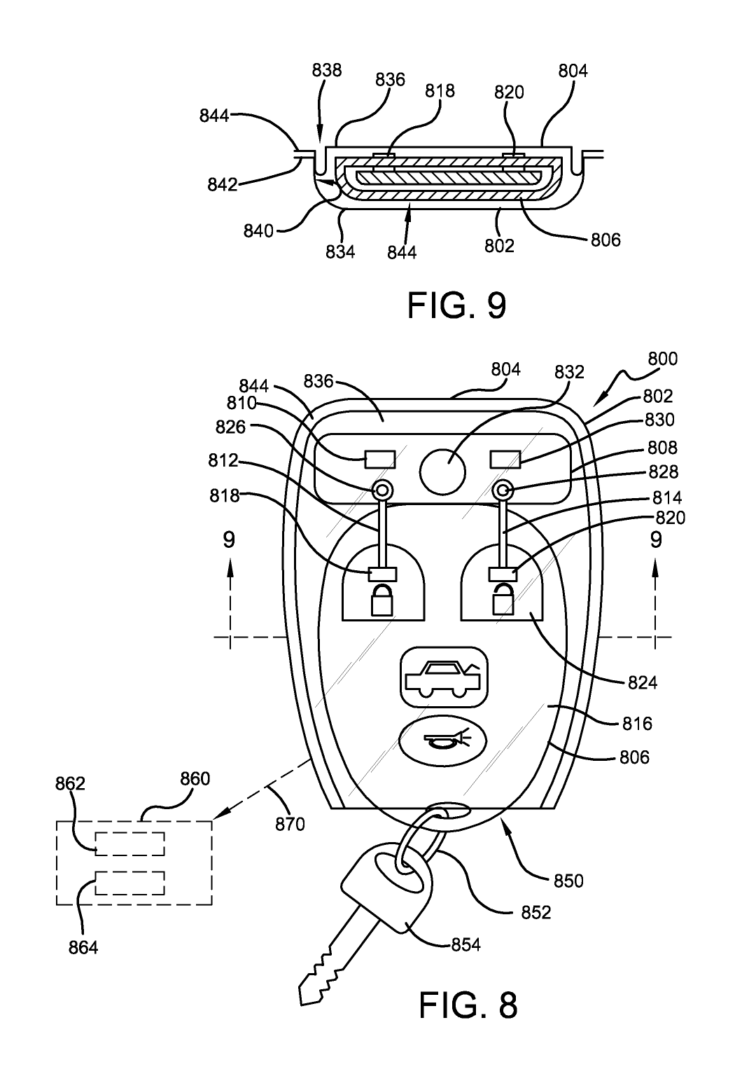

FIG. 8 illustrates an example of a further alternative embodiment of the indicator apparatus 800. In this example, rather than the body of the indicator apparatus having one or more flexible bands that enable the apparatus to wrap around a key fob (such as shown in FIG. 1), the body 802 of the apparatus 800 may instead include an enclosure 804. Such an enclosure 804 is operative to encase all or substantially all of a key fob 806 (which transmits wireless signals 870 that remotely lock and unlock locks 862 for doors 864 of a vehicle 860). In this described embodiment, the enclosure also includes therein a circuit board 808 that includes a controller 810 with the same capabilities described with respect to the controller 114 shown in FIG. 1. The enclosure is adapted to sportingly receive the circuit board 808 inside at least one cavity in the enclosure 804 adjacent an edge (e.g., the top edge) of the key fob 806.

In this described embodiment, the circuit board 808 may include first and second bands 812, 814 (e.g., ribbon cables) that extend outwardly from a common side of the circuit board in order to extend over a top face 816 of the key fob 806. The ends of the first and second bands 812, 814 may include respective first and second switches 818, 820. The bands 812, 814 may have lengths which place the first and second switches 818, 820 over the respective lock and unlock buttons 822, 824 of the key fob 806, when the circuit board and key fob are positioned in the at least one cavity of the enclosure.

The described circuit board 808 may also include first and second light emitters 826, 828 that are spaced apart and respectively aligned with the respective spaced-apart first and second bands 812, 814; first and second switches 818, 812; and/or lock and unlock buttons 822, 824. In addition, the circuit board 808 may include a third switch 832 and one or more battery 832.

In this described embodiment, the controller 810 is in operative connection with the first switch 818, the second switch 820, the third switch 830, the first light emitter 826 and the second light emitter 828. The controller may include or may be in operative connection with a memory 116, and the battery may be configured to provide power needed to operate the controller and the light emitters.

As in the previously described embodiments, the controller 810 is operatively configured to be responsive to activation (e.g., pressing) of the first and second switches 818, 820 (which activation also activates the underlying lock and unlock buttons of the key fob) to store data in the memory that represents which of the first and second switches was activated most recently. In addition, the controller is operatively configured to be responsive to activation of the third switch 830 and the data stored in the memory, to cause the first light emitter 826 to emit light when the data stored in the memory is indicative of the first switch being activated more recently than the second switch. Also, the controller is operatively configured to be responsive to activation of the third switch and the data stored in the memory, to cause the second light emitter 828 to emit light when the data stored in the memory is indicative of the second switch being activated more recently than the first switch.

In this described embodiment, the enclosure 804 portion of the body 802 may correspond to a clear and/or translucent plastic case which encapsulates the key fob 806 and the circuit board 808 in adjacent relation (e.g., the circuit above the top edge of the key fob) so that the first and second switches 818, 820 remain positioned over the lock and unlock buttons.

FIG. 9 illustrates a cross-sectional side view of the body 806. Here, the enclosure 804 of the body may include a bottom base 834 and a top lid 836 which engages with the bottom base without separate fasteners (such as screws, bolts, clips, or an adhesive), in a manner that resists separation of the base and lid during typical use and storage of the key fob. For example, the top lid 836 may include a circumferential compressible portion 838 (e.g., fold, crimp, lip) that extends from one side of the top lid and is adapted to extend into the bottom base 834 and become compressed adjacent an inner face of a circumferential wall 840 of the bottom base 834. The compression fit between the top lid and bottom base is operative to maintain the top lid in engaged relation with the bottom base 834.

Also as shown in FIG. 9, each one of the circumferential wall 840 and the circumferential lip 838 may include respective circumferential flanges 842, 844 that are in overlapped relation around the periphery of the enclosure 804. Such flanges may provide additional rigidity to the enclosure as well as provide a space therebetween for use with prying the top lid away from the bottom base (e.g., to install or remove the key fob).

As shown in FIG. 9, when the top lid 836 is engaged with the bottom base, the enclosure includes at least one cavity 844 therein with a size that is adapted to securely hold the key fob 806 and the described circuit board therein. However, it should also be appreciated that alternative embodiments may use other configurations of enclosures to securely hold a key fob and a circuit board therein. For example, an alternative embodiment may include a single sleeve with a side opening in which the key fob and circuit board are inserted. Such a sleeve may be sized such that the key fob is held sufficiently tight by the walls of the sleeve to prevent the key fob (and the circuit board) from sliding out of the sleeve via gravity.

In these described examples, at least portions of the walls of the enclosure (such as the top lid 836) may be made from a plastic that is sufficiently deformable to enable a user to selectively engage the first and second switches 818, 820 (and the underlying lock and unlock buttons 822, 824) as well as the third switch 830, when pressing down on the portions of the walls of the enclosure overtop of the respective switches 818, 820 830. However, it should be appreciated that in alternative embodiments the enclosure may include apertures through the walls of the enclosure (e.g., through the top lid) adjacent the switches 818, 820, 830, and lock and unlock buttons 822, 824 to enable direct contact of these switches and buttons via fingers of a user. Similarly, the enclosure may include apertures through the walls for other buttons on the key fob.

In this described embodiment, at least portions the walls of the enclosure (e.g., such as the top lid) may be clear and/or sufficiently translucent at the locations of the key fob buttons and/or light emitters, to enable the buttons and/or light switches to be visible through the walls of the enclosure. However, it should be appreciated that alternative embodiments may include all or portions of the enclosure that are opaque. In such embodiments, the outside walls of the enclosure may include symbols, shapes, or other visual cues to identify the location of the buttons of the key fob and/or the first, second, and third switches. Also, apertures may be positioned above the light emitters to enable light from the light emitters to be visible through the enclosure.

Example embodiments of the enclosure may be made out of a plastic such as PET, PVC, polyethylene, polypropylene, or other type of plastic that is capable of being flexible adjacent the buttons of the key fob and switches of the apparatus. Also, alternative embodiments may include at least portions of the enclosure that are made out of other types of materials such as a flexible natural or synthetic rubber, woven cloth, fiberglass, graphite, carbon fiber, titanium, aluminum, other type of metal, ceramics and/or any other material that is operative to encapsulate a key fob and a circuit board.

In addition, it should be appreciated that the enclosure may be comprised of one piece (e.g., a sleeve), two pieces (e.g., a base with a lid), or more pieces. Also, although the described embodiment is operative to mount a top lid onto a bottom base without separate fasteners, it should be appreciated that in alternative embodiments, the multiple pieces of the housing may be engaged together using separate fasteners which include adhesives, screws, bolts, hoop and loop fasters, and or any other type of fastener.

In addition, it should be appreciated that the enclosure may include printed indicia thereon. Such printed indicia may include text, symbols, and other graphics. For example, to enable the locations of the lock and unlock buttons to be more readily identified, lock and unlock symbols and/or text may be located on the portions of the enclosure that overlie the respective lock and unlock buttons.

Referring back to FIG. 9, in one or more embodiments, the enclosure may include at least one aperture 850 therethrough that has a sufficient size to enable at least a portion of a ring 852 mounted to the key fob 806 inside the enclosure 804 to extend through the aperture. The ring exposed in this manner is operative to enable at least one key 854 outside the enclosure to be mountable to the ring. Also, for embodiments of a key fob that include an integral ignition key (not shown) for a vehicle 860, the enclosure may include a further aperture (not shown) through which the ignition key may extend.

In the previously described embodiments, the controllers 114, 708, 810 may be operatively configured to be responsive to activation of the first switch to cause the first light emitter to emit light for a predetermined amount of time (e.g., from 5 to 300 seconds). The controllers 114, 708, 810 are also operatively configured to be responsive to activation of the second switch to cause the second light emitter to emit light for the predetermined amount of time (or a different predetermined amount of time). As a result, if the user looks down at the key fob within the predetermined amount of time after activating the lock or unlock buttons, the user can visually see which button was last pressed (via the adjacent light emitter) without having to press the third switch.

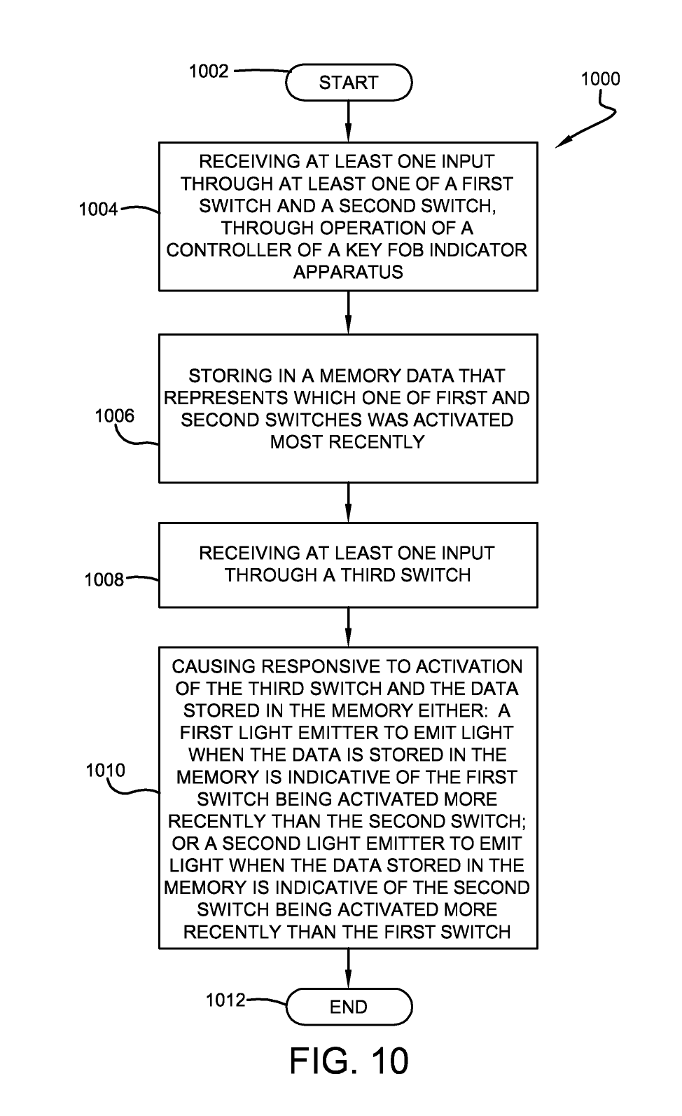

With reference now to FIG. 10, an example methodology is illustrated and described which facilitates using an example embodiment of the previously described indicator apparatuses. While the methodology is described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

As shown in FIG. 10, a methodology 1000 begins at 1002, and at 1004 includes a step of receiving at least one input through at least one of a first switch and a second switch, through operation of a controller included in a body of a key fob indicator apparatus. This described methodology also includes a step 1006 of storing in a memory data that represents which one of first and second switches was activated most recently.

In addition, the methodology may include a step 1008 of receiving at least one input through a third switch and a step 1010 of causing, responsive to activation of the third switch and the data stored in the memory, either: a first light emitter to emit light when the data stored in the memory is indicative of the first switch being activated more recently than the second switch; or a second light emitter to emit light when the data stored in the memory is indicative of the second switch being activated more recently than the first switch. At step 1012, the methodology may end.

As discussed previously, the first switch, the second switch, the third switch, the first light emitter, the second light emitter, and the memory may also be included in the body and may be in operative connection with the controller.

In embodiments of the indicator apparatus where the body includes a flexible band or an enclosure, the apparatus may also include a first projection and a second projection (on one of the faces of a flexible band and/or on the ends of separate bands connected to a circuit board). Such projections may be spaced apart a sufficient distance such that the first projection is adjacent the unlock button and the second projection is adjacent the lock button. Thus, in step 1002, when the input corresponds to receiving manual pressure applied to the body (e.g., applied to portions of the flexible band or enclosure), the manual pressure either: causes activation of the first switch and causes the first projection to activate the unlock button; or causes activation of the second switch and causes the second projection to activate the lock button.

In embodiments of the indicator apparatus where the body is a housing of the key fob, when the lock button (i.e., the first switch) is activated in step 1002, the method also includes the controller causing the RF transmitter to emit an RF signal that is operative to cause at least one lock device to change from an unlocked configuration to a locked configuration. Also, when the unlock button (i.e., the second switch) is activated in step 1002, the method includes the controller causing the RF transmitter to emit an RF signal that is operative to cause the at least one lock device to change from a locked configuration to an unlocked configuration.

In the previously described embodiments, the first switch and the first light emitter are spaced apart on the flexible band and/or inside the enclosure from the second switch and the second light emitter. As a result, a user of the apparatus can visually see that the first light emitter (when)) indicates that the adjacent lock button was activated most recently. Likewise, a user of the apparatus can visually see that the second light emitter (when lighted) indicates that its adjacent unlock button was activated most recently.

However, it should be appreciated that in alternative embodiments, the indicator apparatus (either with a band/enclosure, or integrated into a key fob) may include other types of output devices to indicate which button was last pressed. For example, alternative embodiments may include an LCD screen. When the third button is pressed, the controller may cause the LCD screen (responsive to the data stored in the memory), to display the word “locked” or “unlocked”. Also, rather than display words, the LCD screen may display corresponding symbols such as a picture of locked padlock and an unlocked padlock.

Also, example embodiments may include a sound emitter. The controller may be operative to cause the sound emitter to output different sounds (e.g., chirps and/or verbal words such as “locked” or “unlocked”) depending on which one of the first and second switches was pressed most recently.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. An apparatus comprising;
a body and in operative supported connection with the body:
a first switch;
a second switch, wherein the first and second switches are spaced apart along the body;
a third switch;
a first light emitter;
a second light emitter, wherein the first and second light emitters are spaced apart along the body;
a memory; and
a controller in operative connection with the first switch, the second switch, the third switch, the first light emitter, the second light emitter, and the memory,
wherein the controller is operatively configured to be responsive to activation of the first and second switches to store data in the memory that represents which of the first and second switches was activated most recently,
wherein the controller is operatively configured to be responsive to activation of the third switch and the data stored in the memory to cause:
the first light emitter to emit light when the data stored in the memory is indicative of the first switch being activated more recently than the second switch; and
the second light emitter to emit light when the data stored in the memory is indicative of the second switch being activated more recently than the first switch.

2. The apparatus according to claim 1, wherein the body includes an enclosure, wherein the enclosure includes a cavity therein that is adapted to include the controller, the first switch, the second switch, the third switch, the first light emitter, the second light emitter, the memory, and a key fob therein, such that the first switch remains in a location covering at least a portion of a lock button of the key fob and the second switch remains in a location covering at least a portion of an unlock button of the key fob, wherein manual pressure applied to the first switch is operative to activate both the first switch and the lock button, wherein manual pressure applied to the second switch is operative to activate both the second switch and the unlock button.

3. The apparatus according to claim 2, further comprising the key fob.

4. The apparatus according to claim 2, wherein the enclosure includes at least one portion adjacent the first switch and the second switch that is sufficiently flexible such that manual pressure applied to the at least one portion of the enclosure adjacent the first switch is operative to activate both the first switch and cause activation of the lock button and that is sufficient flexible such that manual pressure applied to the at least one portion of the enclosure adjacent the second switch is operative to activate both the second switch and cause activation of the unlock button.

5. The apparatus according to claim 4, wherein the at least one portion of the enclosure extends adjacent the third switch and is sufficiently flexible such that manual pressure applied to the at least one portion of the enclosure adjacent the third switch is operative to activate the third switch.

6. The apparatus according to claim 5, wherein the enclosure is comprised of at least one of a transparent and a translucent material, wherein light from each of the first and second light emitters is visible through the enclosure.

7. The apparatus according to claim 6, wherein the enclosure includes a top lid and a bottom base, wherein the top lid is operative to mount to the bottom base without separate fasteners.

8. The apparatus according to claim 6, wherein the enclosure is adapted to include the controller, the first switch, the second switch, the third switch, the first light emitter, the second light emitter, a memory, and a key fob in the cavity, such that the first light emitter is positioned relatively closer to the first switch than the second switch, and such that the second light emitter is positioned relatively closer to the second switch than the first switch.

9. The apparatus according to claim 2, wherein the enclosure includes at least one aperture therethough, wherein the aperture has a sufficient size to enable at least a portion of a ring mounted to a key fob inside the enclosure to extend through the aperture, whereby keys outside the enclosure are mountable to the ring.

10. The apparatus according to claim 1, wherein the body includes at least one band having an inner face surface and an outer face surface, wherein the at least one band includes a first projection and a second projection, wherein the first projection and the second projection are spaced apart and extend outwardly from the inner face surface, wherein the first and second projections are at least one of included by or in operative connection respectively with the first and second switches, wherein the first and second light emitters are operative to output light that is visible on a side of the body that includes the outer face surface of the at least one band, wherein the at least one band is sufficiently flexible to enable the body to wrap around a key fob that includes an unlock button and a lock button, wherein the first and second projections are spaced apart a sufficient distance such that when the body is mounted to the key fob, the first projection is adjacent the lock button and the second projection is adjacent the unlock button, wherein manual pressure applied to the first switch is operative to activate both the first switch and cause the first projection to activate the lock button, wherein manual pressure applied to the second switch is operative to activate both the second switch and cause the second projection to activate the unlock button.

11. The apparatus according to claim 1, wherein the body is a housing of a key fob, wherein the key fob includes an RF transmitter mounted in the housing in operative connection with the controller, wherein the key fob includes an unlock button and a lock button, wherein the lock button includes the first switch, wherein the unlock button includes the second switch, wherein the controller is further responsive to activation of the first switch to cause the RF transmitter to emit an RF signal that is operative to cause at least one lock device to change from an unlocked configuration to a locked configuration, wherein the controller is further responsive to activation of the second switch to cause the RF transmitter to emit an RF signal that is operative to cause the at least one lock device to change from the locked configuration to the unlocked configuration.

12. The apparatus according to claim 11, further comprising a vehicle, wherein the vehicle includes the at least one lock device, wherein the at least one lock device is operative to lock and unlock at least one door of the vehicle.

13. The apparatus according to claim 1, wherein the controller includes a processor, wherein the processor includes the memory, further comprising a battery in operative connection with the controller.

14. The apparatus according to claim 1, wherein the controller is operatively configured to be responsive to activation of the first switch to cause the first light emitter to emit light for a predetermined amount of time, wherein the controller is operatively configured to be responsive to activation of the second switch to cause the second light emitter to emit light for a predetermined amount of time.

15. A method comprising;
a) responsive to activation of at least one of a first switch and a second switch, through operation of a controller in operatively supported connection with a body, storing in a memory data that represents which one of the first and the second switches was activated most recently, wherein the first switch, the second switch, a third switch, a first light emitter, a second light emitter, and the memory are in operative connection with the body and are in operative connection with the controller, wherein the first and second switches are spaced apart along the body, wherein the first and second light emitters are spaced apart along the body;
b) responsive to activation of the third switch and the data stored in the memory, through operation of the controller, causing either: the first light emitter to emit light when the data stored in the memory is indicative of the first switch being activated more recently than the second switch; or the second light emitter to emit light when the data stored in the memory is indicative of the second switch being activated more recently than the first switch.

16. The method according to claim 15, wherein in (a) the body includes an enclosure, wherein the enclosure includes a cavity therein that is adapted to include the controller, the first switch, the second switch, the third switch, the first light emitter, the second light emitter, a memory, and a key fob therein, such that the first switch remains in a location covering at least a portion of a lock button of the key fob, and the second switch remains in a location covering at least a portion of an unlock button of the key fob, wherein manual pressure applied to the first switch is operative to activate both the first switch and the lock button, wherein manual pressure applied to the second switch is operative to activate both the second switch and the unlock button,
further comprising:
c) prior to (a) receiving manual pressure applied to a portion of the enclosure, wherein the manual pressure either:
causes activation of the first switch and the lock button; or
causes activation of the second switch and the unlock button;
wherein in (b) the first light emitter is located closer to the lock button than the unlock button, wherein in (b) the second light emitter is located closer to the unlock button than the lock button.

17. The method according to claim 15, wherein the body is a housing of a key fob, wherein the key fob includes an RF transmitter mounted in the housing in operative connection with the controller, wherein the key fob includes a lock button and an unlock button, wherein the lock button includes the first switch, wherein the unlock button includes the second switch, wherein in (a):
when the first switch is activated, (a) includes the controller causing the RF transmitter to emit an RF signal that is operative to cause at least one lock device to change from an unlocked configuration to a locked configuration, and
when the second switch is activated, (a) includes the controller causing the RF transmitter to emit an RF signal that is operative to cause the at least one lock device to change from the locked configuration to the unlocked configuration.

18. The method according to claim 17 wherein in (a) the at least one lock device is included in a vehicle, wherein the at least one lock device is operative to lock and unlock at least one door of the vehicle.

19. The apparatus according to claim 15, wherein in (a) responsive to activation of at least one of the first and second switches, through operation of the controller, either:
causing the first light emitter to emit light for a predetermined amount of time when the first switch is activated; or
causing the second light emitter to emit light for a predetermined amount of time when the second switch is activated.
